(19) United States
(12) Patent Application Publication
(10) Pub. No.: US 2011/0284578 A1
(43) Pub. Date: Nov. 24, 2011

(54) OIL AND FLAVORING POT

(76) Inventor: DAI-CHONG WONG, Hong Kong (CN)

(21) Appl. No.: 13/110,827

(22) Filed: May 18, 2011

(30) Foreign Application Priority Data
May 20, 2010 (CN) 201020197942.0

(51) Int. Cl. B67D 7/16

(52) U.S. Cl. 222/40

(57) ABSTRACT

An oil and flavoring pot includes a pot body having a measuring cup and a handle. A liquid squeezing structure is disposed on a pot lid, and capacity value and a residue recycling structure is formed on a cup wall. The liquid squeezing structure could press the flavoring into the measuring cup by one time or sequence times, and the operation could stop at any time. The amount of the flavoring could be read at any time. When the amount reaches to target, the operation of the liquid squeezing structure could be stopped and the target amount of flavoring is obtained, therefore facilitating to control and know the feeding amount. After use, the residue liquid flows to the groove along wall of the spout, and flows into the measuring cup through the cup slot, therefore keep the pot body clean. Furthermore, the pot is conveniently operated by a single hand.

### FIELD OF THE INVENTION

The present invention relates to an oil pot and a flavoring pot, especially to an oil and flavoring pot which could control discharge amount, know the real usage amount and could make the flavoring residue at the spout after use could not contaminate the pot body and other places.

### BACKGROUND OF THE INVENTION

Because the society is increasingly prosperity, requirement of delicious and healthy food is sequentially increased. Flavoring plays an important role in cooking delicious and healthy food, and especially, controlling the usage amount of the flavoring is more important.

For containing liquid flavoring, various kinds of containers are provided in the market. An oil pot shown in FIG. 11 has a spout formed on the pot body. When used, the liquid flavoring is poured out from the spout, but such pot could not control the usage amount of the liquid flavoring. Furthermore, after use, the liquid flavoring residues at the spout flows along the outer wall of the spout and further contaminate the pot body and other places. A suit of measuring spoon shown in FIG. 10 ties spoons of different capacities together. When used, a suitable spoon is selected for containing the liquid flavoring and comparting the liquid flavoring by measuring scale. However, this spoon suit needs to be used by both hands. Although being carefully used, the flavoring in the spoon is either poured over or not enough, and therefore, could not control the usage amount. Furthermore, the spoon suit needs to be cleaned each time after being used, which complicates the usage of the spoon suit. A sprinkling pot being used as oil/flavoring pot is shown in FIG. 12. The sprinkling pot includes a liquid squeezing structure fixed on a pot body by a pot lid. When used, the liquid flavoring in the pot body is pressed and jet out by the liquid squeezing structure. Sometimes, the liquid squeezing structure may be operated by a press-and-release manner, and the flavoring may jet out in an impulse manner. However, the usage amount of the flavoring could not be controlled and the real usage amount could not be known. Furthermore, breakers caused by jet flow will contaminate nearby stuffs and places. Moreover, after use, the liquid flavoring residues at the spout flows along the outer wall of the spout and further contaminate the pot body and other places, and therefore complicates the usage.

### SUMMARY OF THE INVENTION

The present invention provides an oil and flavoring pot, which includes liquid squeezing structure, measuring cup and residue recycling structure to realize ration use and residue recycle, and overcomes the shortages of could not control the usage amount and contamination problem existed in the conventional techniques.

In order to achieve at least of the above-mentioned advantages, the present invention provides an oil and flavoring pot having a pot body. The pot body has a spout and a handle. A liquid squeezing structure is detachably attached to a pot opening of the pot body. The pot body further includes a measuring cup and a residue recycling structure. The measuring cup communicates with an inner cavity of the pot body through the liquid squeezing structure. The spout is disposed to a mouth of the measuring cup. The residue recycling structure includes at least a groove formed beneath the spout and at least a cup slot formed on a sidewall of the measuring cup. The groove bypasses the mouth of the measuring cup, slantingly and downwardly extends to the outer wall of the pot body. The cup slot is defined in a cup wall of the measuring cup at positions corresponding to a connection portion of the groove and the pot body. Liquid residue at the spout flows into the measuring cup through the groove and the cup slot. The measuring cup has a measuring scale and a capacity value formed on the measuring cup.

The techniques further includes: the pot body includes a pot opening and the stuffing squeezing structure is disposed at a mouth of the pot opening. The liquid squeezing structure includes a bracket, a pump lid and a pressing arm. The bracket has a pump and a pump inlet is disposed at a lower portion of the pump. An inlet valve is disposed beneath the pump inlet. A straw is connected beneath the inlet valve. A piston is disposed in the pump. A first spring is disposed between a bottom surface of the piston and the inlet valve. A piston rod is disposed at a top end of the piston and a top end of the piston rod is connected with a middle portion of the pressing arm. An outlet pipe is disposed inside the piston rod and a bottom end of the outlet pipe communicates with an inner cavity of the pump. A piston rod outlet is formed on an outer round wall of the piston rod and the piston rod outlet communicates with a top portion of the outlet pipe of the piston rod. An outlet valve is disposed inside the outlet pipe and a second spring is disposed between the outlet valve and a top surface of the outlet pipe. A pump lid is disposed on an upper portion of the pump. A sleeve and a pump lid exhausting cavity are disposed on the pump lid. The sleeve is disposed around the piston rod. A sleeve opening is defined in the sleeve and communicates with the piston rod outlet. The pump lid exhausting cavity respectively communicates with the sleeve opening and the measuring cup. A pin is disposed on the bracket and hinged with an end of the pressuring arm. A top lid is disposed on the bracket and a top lid cutout is defined in the top lid. The other end of the pressuring arm extends beyond the top lid cutout and capable of swinging up and down in the top lid cutout.

The pot body includes a pot opening and the stuffing squeezing structure is disposed at a mouth of the pot opening. The liquid squeezing structure includes a bracket, a pump lid and a pressing arm. The bracket has a pump and a pump inlet is disposed at a lower portion of the pump. An inlet valve is disposed beneath the pump inlet and a straw is connected beneath the inlet valve. A piston rod is disposed in the pump and a flange is formed at a bottom end of the piston rod. A plurality of inlet cutouts are defined in an outer round wall of the flange. A first spring is disposed between a bottom surface of the flange of the piston rod and the inlet valve. A cone frustum is formed on the flange, and the cone frustum is surrounded by a cone frustum bevel. An outlet pipe is disposed inside the piston rod and a bottom end of the outlet pipe extends to a top end of the cone frustum. A piston rod inlet is formed on an outer round wall of the piston rod at a position corresponding to a bottom end of the outlet pipe, and the piston rod inlet communicates with the outlet pipe. A piston rod outlet is formed on an outer round wall of the piston rod at a position corresponding to a top end of the outlet pipe. The piston rod outlet communicates with the outlet pipe. A piston rod sleeve is disposed around the piston rod and a top end of the piston rod sleeve connects with a middle portion of the pressing arm. A piston rod sleeve bevel is formed around a lower outer round wall of the piston rod sleeve. A piston rod sleeve outlet is formed on an outer round wall of the piston rod sleeve at a position corresponding to the piston rod outlet. The piston rod sleeve outlet communicates with the piston rod outlet. A trunk piston is disposed between the piston rod sleeve and the flange. The piston is capable of moving between the flange and the piston rod sleeve. An outer diameter of the piston matches with an inner diameter of the pump. A piston upper bevel is formed around an upper inner round wall of the piston and the piston upper bevel matches with the piston rod sleeve bevel. A piston lower bevel is formed around a lower inner round wall of the piston and the piston lower bevel matches with the cone frustum bevel. A pump lid is disposed on a top portion of the pump. A sleeve and a pump lid exhausting cavity are disposed on the pump lid. The sleeve is disposed around the piston rod sleeve. A sleeve opening is defined in the sleeve and communicates with piston rod sleeve outlet. The pump lid exhausting cavity respectively communicates with the sleeve opening and the measuring cup. A pin is disposed on the bracket and hinged with an end of the pressuring arm. A top lid is disposed on the bracket and a top lid cutout is defined in the top lid. The other end of the pressuring arm extends beyond the top lid cutout and capable of swinging up and down in the top lid cutout.

The detachable attachment includes a pump flange formed on an outer wall of the pump. A pot lid is disposed between the pump flange and the bracket. Screw threads formed on the pot lid match with screw threads formed on the pot opening. A sealing pad is disposed between the pump flange and the pot opening.

A recess is formed at the top end of the piston rod sleeve. A protrusion is formed at a middle portion of the pressing arm and matches with the recess.

A recess is formed at the top end of the piston rod sleeve. A protrusion is formed at a middle portion of the pressing arm and matches with the recess.

The advantages of the present invention is: after utilizing the forgoing structures, the oil and flavoring pot has the measuring cup and the liquid squeezing structure, the liquid flavoring in the pot could be pressed into the measuring cup by operating the liquid squeezing structure. The operation of the liquid squeezing structure could be performed by only one time or sequence times, and the operation could also be stopped at any time. Furthermore, because the measuring cup includes the measuring scale and the capacity value formed on its cup wall, therefore, the amount of the liquid flavoring in the measuring cup could be known at any time. Therefore, when the amount of the liquid flavoring in the measuring cup reaches the target amount, the operation of the liquid squeezing structure could be stopped immediately to stop feeding the liquid flavoring into the measuring cup, thereby facilitating to control the feeding amount and clearly know the real feeding amount of the liquid flavoring. Thus, the usage amount of the liquid flavoring could be changed from estimated amount to the real amount. When used in cooking, it benefits for keeping cooking level, improving taste and healthy cooking. Furthermore, because the liquid pressed by the liquid squeezing structure is poured out in jet flow manner, the measuring cup will accept the liquid flavoring and limit the liquid breakers, so that the liquid breakers could not splashed outside and therefore could not contaminated other places. Moreover, after use, the grooves could guide the liquid residue at the spout to flow into the measuring cup through the cup slots, thereby preventing the residue liquid from contaminating the pot body and other places and therefore could keep a clean use condition. In addition, when used, the hand hold the handle could operate the liquid squeezing structure simultaneously, thus, the pot could be operated by one hand and thereby facilitating the operation of the pot.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic, cross sectional view of an oil and flavoring pot according to an embodiment of the present invention.

FIG. 2 is left view of the oil and flavoring pot of FIG. 1.

FIG. 3 is top view of the oil and flavoring pot of FIG. 1.

FIG. 4 is cross sectional view of FIG. 1, taken along line A-A thereof.

FIG. 5 is cross sectional view of FIG. 1, taken along line B-B thereof.

FIG. 6 is cross sectional view of FIG. 1, taken along line C-C thereof.

FIG. 7 is a schematic, cross sectional view of an oil and flavoring pot according to another embodiment of the present invention, wherein the liquid squeezing structure is different from FIG. 1.

FIG. 8 is cross sectional view of FIG. 7, taken along line M-M thereof.

FIG. 9 is cross sectional view of FIG. 7, taken along line N-N thereof.

FIG. 10 is a schematic view of a conventional technique.

FIG. 11 is a schematic view of another conventional technique.

FIG. 12 is a schematic view of a further conventional technique.

FIG. 13 is a schematic view showing an unused state of the present invention.

FIG. 14 is a schematic view showing a liquid squeezing state of the present invention.

FIG. 15 is a schematic view showing a liquid filling state of the oil and flavoring pot of the present invention.

FIG. 16 is a schematic view showing a liquid pouring state of the present invention.

FIG. 17 is a schematic view showing a state that elements return to its original position after the present invention being used.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

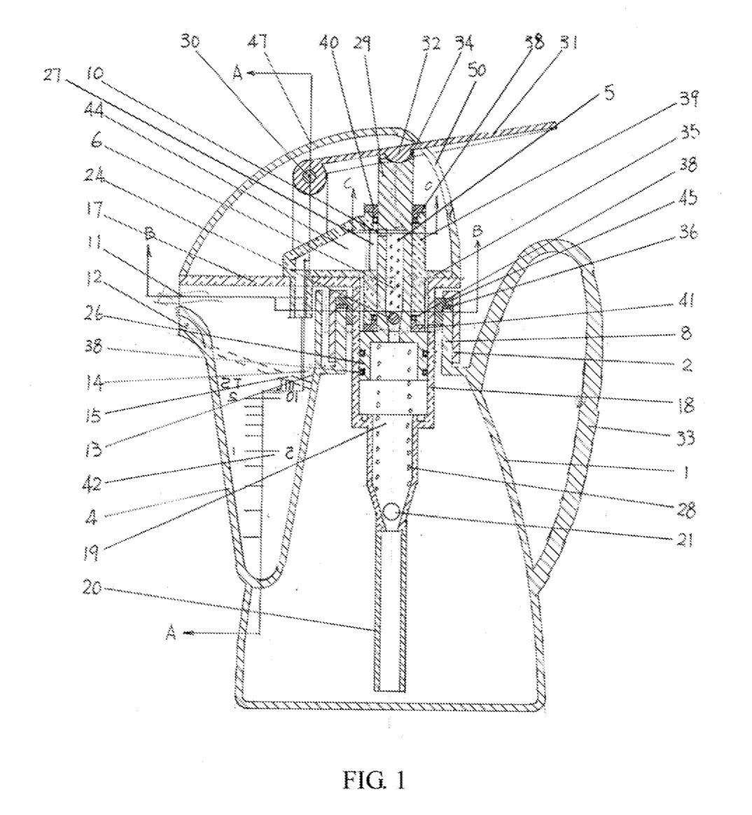

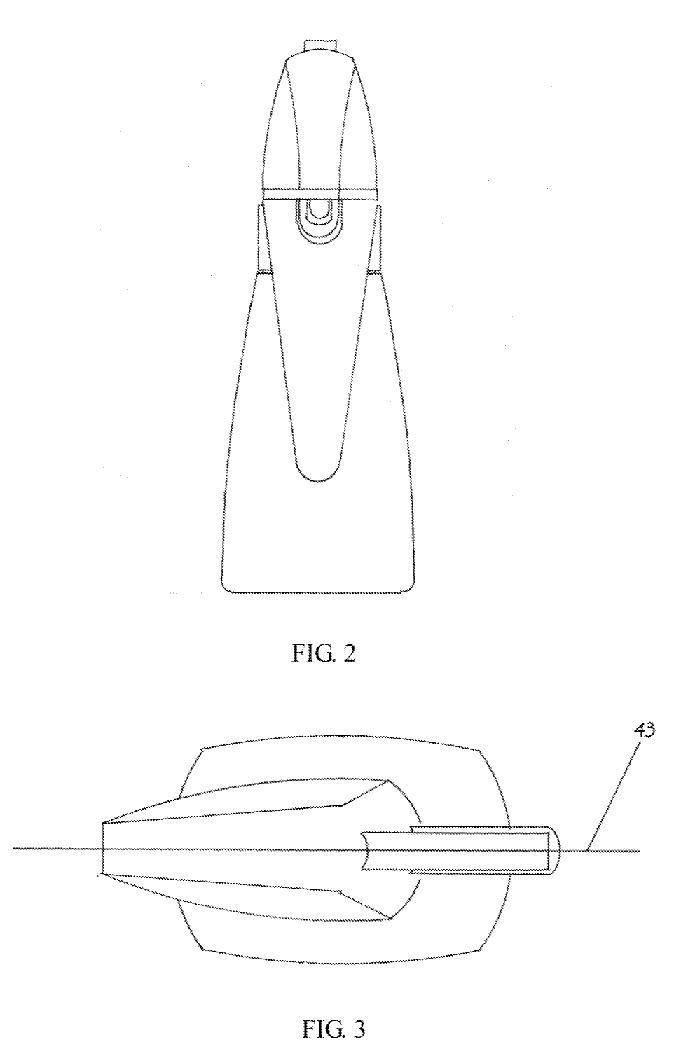

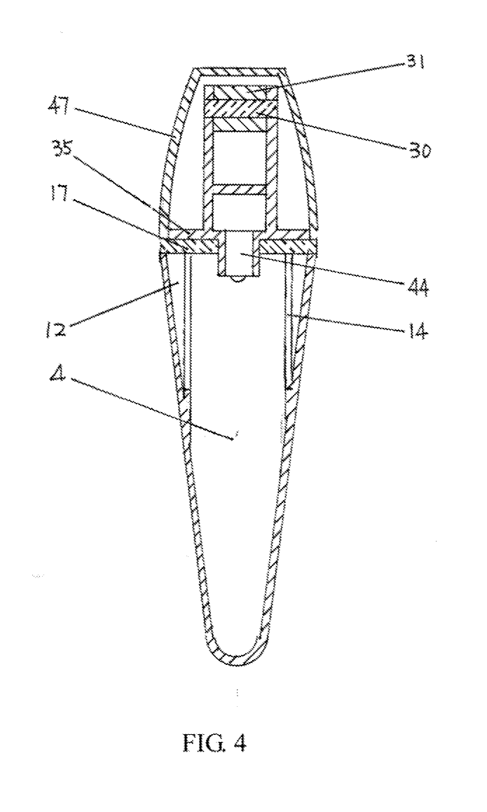

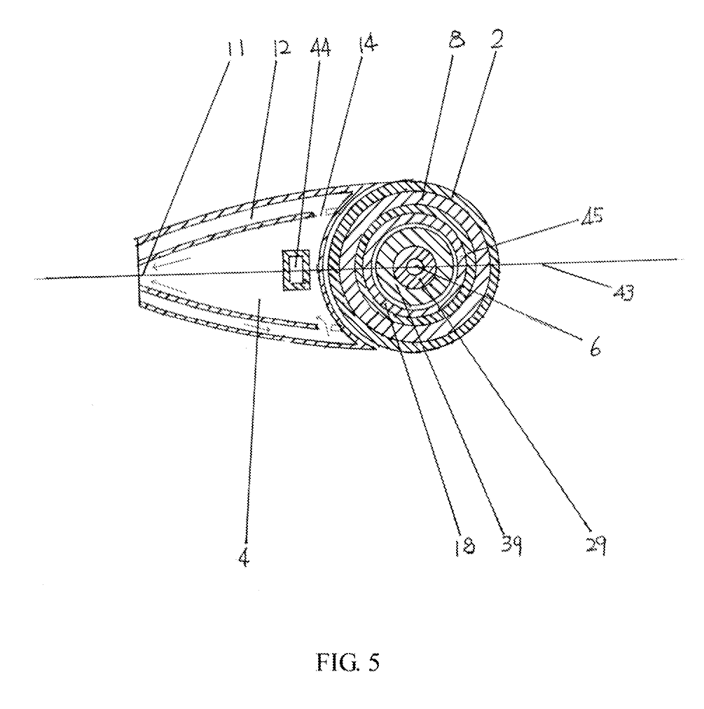

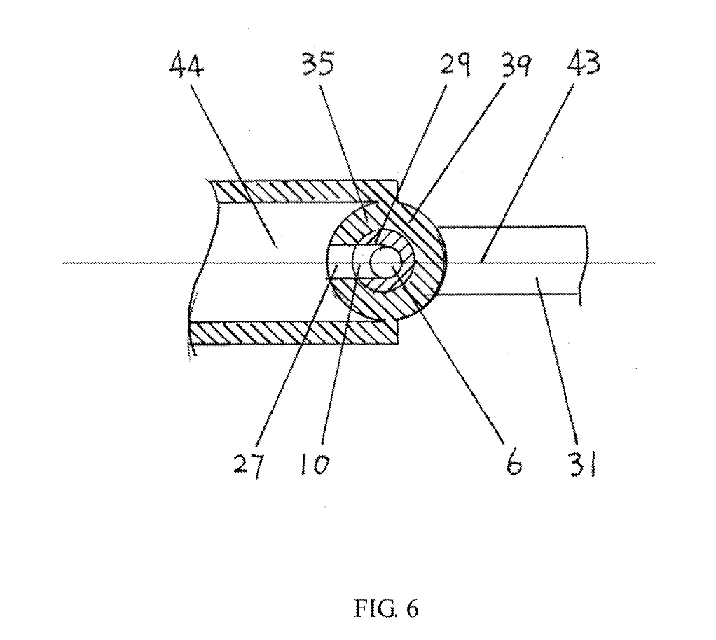

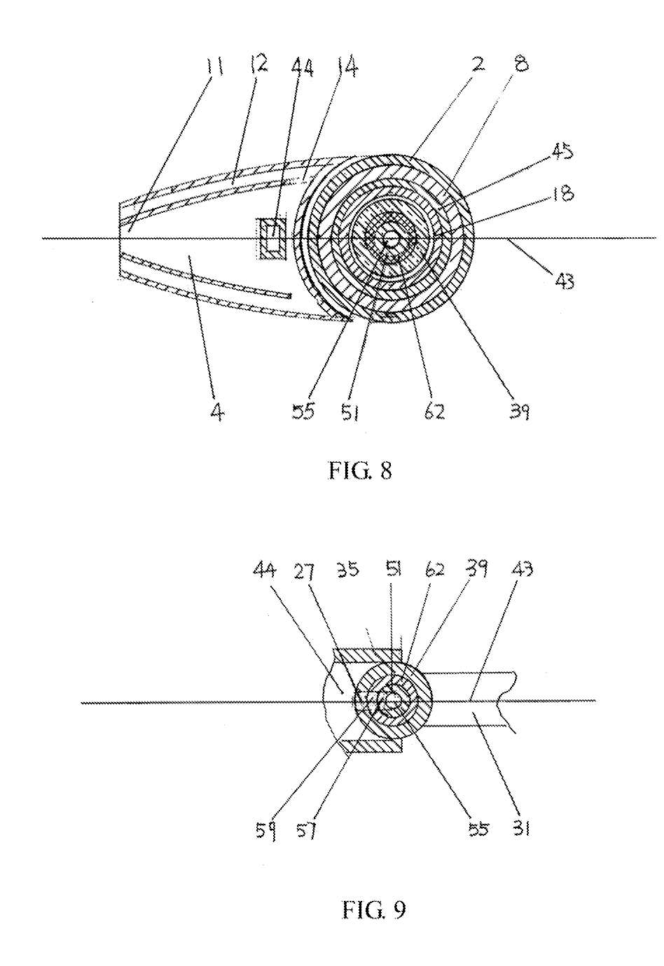

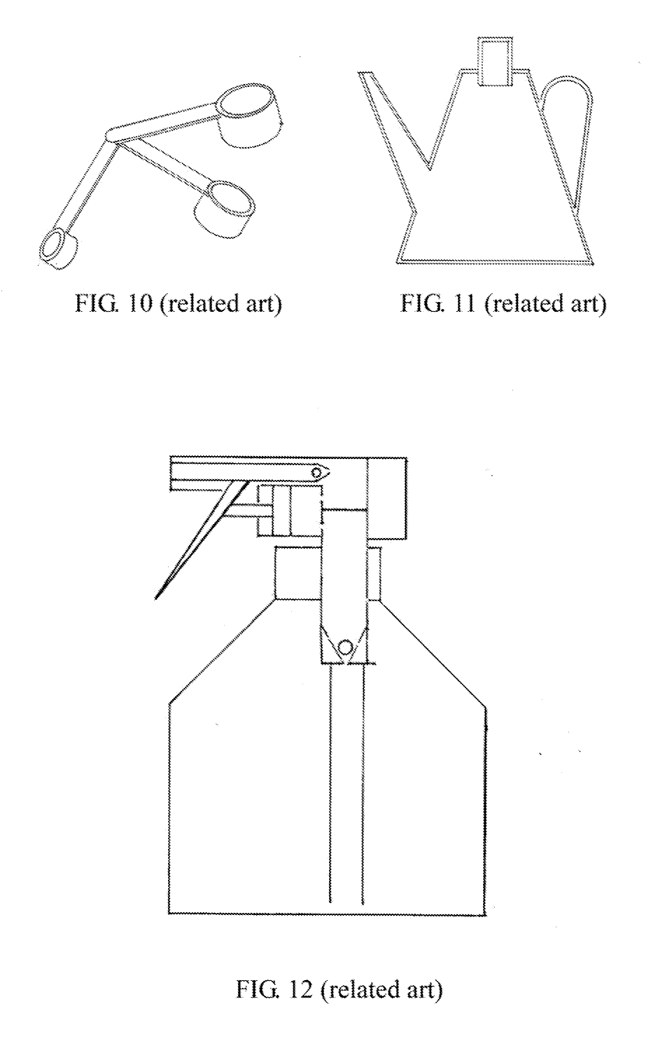

The oil and flavoring pot of the present invention includes a pot body 1, a pot opening 8, a spout 11, a handle 33, a pot lid 2, a liquid squeezing structure, and a residue recycling structure. The liquid squeezing structure is detachably attached to the pot opening 8. The liquid squeezing structure of the present invention has two embodiments, which are respectively shown in FIGS. 1 to 6 and FIGS. 7 to 9, and the two embodiments are respectively described as below.

Referring to FIGS. 1 to 6, the first embodiment of the present invention includes the pot body 1, the pot opening 8, the spout 11, and handle 33, the pot lid 2, the liquid squeezing structure, a measuring cup 4 and the residue recycling structure. The measuring cup 4 communicates with an inner cavity of the pot body 1 through the liquid squeezing structure. The spout 11 communicates with the measuring cup 4. The pot lid 2 may connect the liquid squeezing structure to the pot opening 8 or detach the liquid squeezing structure from the pot opening 8.

The pot body 1 includes the measuring cup 4 and the handle 33 respectively disposed at opposites sides of the pot body 1. The pot opening 8 is disposed at a top end of the pot body 1.

The measuring cup 4 includes the spout 11 and has measuring scale 42 formed on the measuring cup 4.

The residue recycling structure includes two grooves 12 formed beneath the spout 11 and two cup slots 14 formed on a sidewall of the measuring cup 4. The grooves 12 communicate with the measuring cup 4 through the cup slots 14.

The detachable attachment includes a pump flange 45 formed on an outer wall of a pump 18 and the pot lid 2.

The liquid squeezing structure includes a bracket 17, the pump 18, a pump inlet 19, an inlet valve 21, a straw 20, a first spring 28, a piston 26, a piston rod 29, an outlet pipe 6, a piston rod outlet 10, an outlet valve 24, a second spring 5, a recess 34, a pump lid 35, a sleeve 39, a sleeve opening 27, a pump lid exhausting cavity 44, a pin 30, a pressing arm 31, a protrusion 32, a top lid 47, and a top lid cutout 50.

Connections of the Forgoing Elements:

The measuring cup 4 is disposed on the outer wall of the pot body 1 at a position opposite to the handle 33. The spout 11 is disposed to a mouth of the measuring cup 4 at an end distant from the pot body 1. The grooves 12 are disposed beneath the spout 11, bypass the mouth of the measuring cup 4, slantingly and downwardly extend and finally connect to the outer wall of the pot body 1. The cup slots 14 are defined in the cup wall of the measuring cup 4 at positions corresponding to connection portions 13 of the grooves 12 and the pot body 1. A depth of the cup slot 14 is from the mouth of the measuring cup 4 to a groove bottom 15 of corresponding groove 12. The liquid residue at the spout 11 flows into the measuring cup 4 through the grooves 12 and the cup slots 14. The measuring scale 42 and a capacity value are formed on the cup wall of the measuring cup 4. The bracket 17 is disposed above the pot opening 8, and the pump 18 is disposed beneath the bracket 17. The pump inlet 19 is disposed at a lower portion of the pump 18, and the inlet valve 21 is disposed beneath the pump inlet 19. The straw 20 is connected beneath the inlet valve 21. The piston 26 is disposed in the pump 18, and a sealing ring 46 is disposed between an outer round surface of the piston 26 and an inner round surface of the pump 18. The first spring 28 is disposed between the piston 26 and the inlet valve 21, and the piston rod 29 is disposed at a top end of the piston 26. The recess 34 is formed at a top end of the piston rod 29, and the outlet pipe 6 is disposed inside the piston rod 29. A bottom end of the outlet pipe 6 communicates with an inner cavity of the pump 18. The piston rod outlet 10 is formed on an outer round wall of the piston rod 29. The piston rod outlet 10 communicates with a top portion of the outlet pipe 6 of the piston rod 29, and the outlet valve 24 is disposed inside the outlet pipe 6. The second spring 5 is disposed between the outlet valve 24 and a top surface of the outlet pipe 6. The pump lid 35 is disposed on an upper portion of the pump 18. The sleeve 39 and the pump lid exhausting cavity 44 are disposed on the pump lid 35. The sleeve 39 is disposed around the piston rod 29. The sleeve opening 27 is defined in the sleeve 39 and communicates with the piston rod outlet 10. The pump lid exhausting cavity 44 respectively communicates with the sleeve opening 27 and the measuring cup 4. The pin 30 is disposed on the bracket 17, and hinged with an end of the pressuring arm 31. The protrusion 32 is formed at a middle portion of the pressing arm 31, and matches with the recess 29 of the piston rod 29. The top lid 47 is disposed on the bracket 17 and the top lid cutout 50 is defined in the top lid 47. The other end of the pressuring arm 31 extends beyond the top lid cutout 50 and capable of swinging up and down in the top lid cutout 50.

An upper sleeve lid 40 is disposed between a top end of the sleeve 39 and the piston rod 29. A sealing ring 38 is disposed between the upper sleeve lid 40 and the piston rod 29. A lower sleeve lid 41 is disposed between a bottom end of the sleeve 39 and the piston rod 29. Another sealing ring 38 is disposed between the lower sleeve lid 41 and the piston rod 29.

The pump flange 45 is formed on the outer wall of the pump 18. The pot lid 2 is disposed between the pump flange 45 and the bracket 17. Screw threads formed on the pot lid 2 match with screw threads formed on the pot opening 8. A sealing pad 36 is disposed between the pump flange 45 and the pot opening 8.

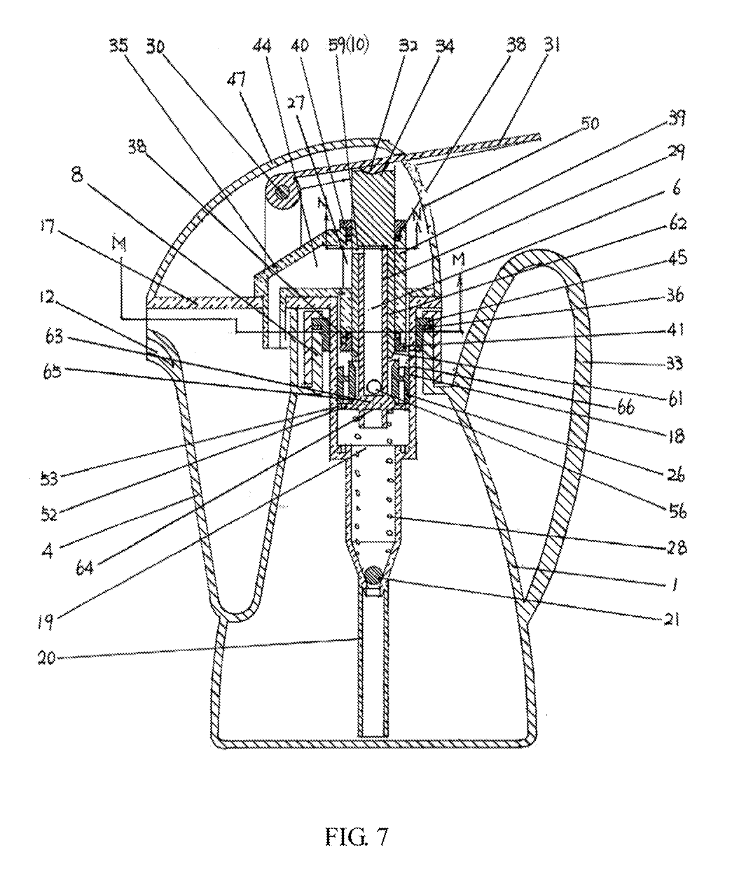

As shown in FIGS. 7 to 9, the second embodiment of the present invention is substantially the same as the first embodiment except for the liquid squeezing structure.

The liquid squeezing structure of the second embodiment includes a bracket 17, a pump 18, a pump inlet 19, an inlet valve 21, a straw 20, a first spring 28, a piston rod 29, a flange 52, an inlet cutout 53, a cone frustum 63, a cone frustum bevel 64, a piston rod inlet 56, an outlet pipe 6, a piston rod outlet 10, a piston 26, a piston upper bevel 66, a piston lower bevel 65, a piston rod sleeve 62, a piston rod sleeve outlet 59, a piston rod sleeve bevel 61, a pump lid 35, a sleeve 39, a sleeve opening 27, a pump lid exhausting cavity 44, a pin 30, a pressing arm 31, a protrusion 32, a top lid 47, and a top lid cutout 50 and a recess 34.

Connections of the Forgoing Elements:

The pump 18 is disposed beneath the bracket 17, and the pump inlet 19 is disposed at a lower portion of the pump 18. The inlet valve 21 is disposed beneath the pump inlet 19, and the straw 20 is connected beneath the inlet valve 21. The piston rod 29 is disposed in the pump 18, and the flange 52 is formed at the bottom end of the piston rod 29. A plurality of inlet cutouts 53 are defined in an outer round wall of the flange 52. The first spring 28 is disposed between a bottom surface of the flange 52 of the piston rod 29 and the inlet valve 21. The cone frustum 63 is formed on the flange 52, and the cone frustum 63 is surrounded by the cone frustum bevel 64. The outlet pipe 6 is disposed inside the piston rod 29. The bottom end of the outlet pipe 6 extends to the top end of the cone frustum 63. The piston rod inlet 56 is formed on an outer round wall of the piston rod 29 at a position corresponding to the bottom end of the outlet pipe 6, and the piston rod inlet 56 communicates with the outlet pipe 6. The piston rod outlet 10 is formed on an outer round wall of the piston rod 29 at a position corresponding to the top end of the outlet pipe 6, and the piston rod outlet 10 communicates with the outlet pipe 6. The piston rod sleeve 62 is disposed around the piston rod 29, and the recess 34 is formed at the top end of the piston rod sleeve 62. The piston rod sleeve bevel 61 is formed around a lower outer round wall of the piston rod sleeve 62. The piston rod sleeve outlet 59 is formed on an outer round wall of the piston rod sleeve 62 at a position corresponding to the piston rod outlet 10, and the piston rod sleeve outlet 59 communicates with the piston rod outlet 10. The trunk piston 26 is disposed between the piston rod sleeve 62 and the flange 52. An outer diameter of the piston 26 matches with an inner diameter of the pump 18, and the piston 26 is capable of moving between the flange 52 and the piston rod sleeve 62. The piston upper bevel 66 is formed around an upper inner round wall of the piston 26, and the piston upper bevel 66 matches with the piston rod sleeve bevel 61. The piston lower bevel 65 is formed around a lower inner round wall of the piston 26, and the piston lower bevel 65 matches with the cone frustum bevel 64. The pump lid 35 is disposed on a top portion of the pump 18. The sleeve 39 and the pump lid exhausting cavity 44 are disposed on the pump lid 35. The sleeve 39 is disposed around the piston rod sleeve 62. The sleeve opening 27 is defined in the sleeve 39 and communicates with piston rod sleeve outlet 59. The pump lid exhausting cavity 44 respectively communicates with the sleeve opening 27 and the measuring cup 4. The pin 30 is disposed on the bracket 17, and hinged with an end of the pressuring arm 31. The protrusion 32 is formed at a middle portion of the pressing arm 31, and matches with the recess 34. The top lid 47 is disposed on the bracket 17 and the top lid cutout 50 is defined in the top lid 47. The other end of the pressuring arm 31 extends beyond the top lid cutout 50 and capable of swinging up and down in the top lid cutout 50. An upper sleeve lid 40 is disposed between a top end of the sleeve 39 and the piston rod sleeve 62, and a sealing ring 38 is disposed between the upper sleeve lid 40 and the piston rod sleeve 62. A lower sleeve lid 41 is disposed between a bottom end of the sleeve 39 and the piston sleeve 62, and another sealing ring 38 is disposed between the lower sleeve lid 41 and the piston rod sleeve 62.

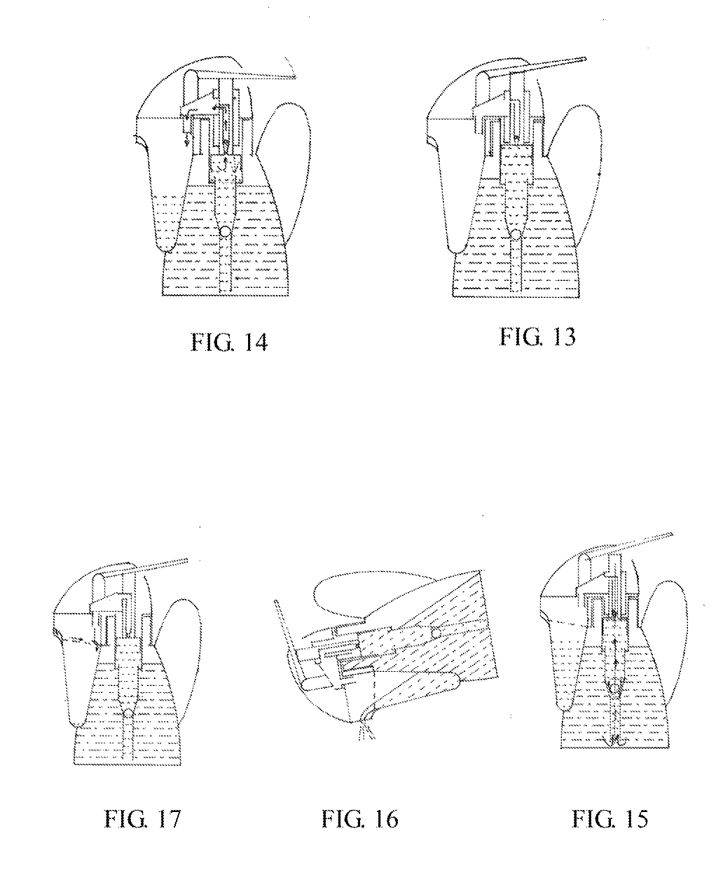

Referring to FIGS. 13-17, operation of the present invention is described as below.

The oil and flavoring pot is in an original state before use. Meanwhile, the pressing arm 31, the piston rod 29 and the piston 26 are located at the highest point. The pump 18 of the liquid squeezing structure is filled with liquid flavoring. The inlet valve 21 and the outlet valve 24 are shut off. In the original state of the other embodiment, the pressing arm 31, the piston rod sleeve 62, the piston rod 29 and the piston 26 are located at the highest point. The pump 18 of the liquid squeezing structure is filled with liquid flavoring. The inlet valve 21 is shut off. The piston lower bevel 65 of the piston 26 intimately contacts with the cone frustum bevel 64 of the cone frustum 63, and the piston rod inlet 56 is shut off. When used, the user firstly decides the target amount of the liquid flavoring according to practical situation and experience, and then holds up the pot and presses the pressing arm 31 by fingers of the hold hand, to drive the piston rod 29 and the piston 26 to push the liquid flavoring in the pump 18. The pressed liquid flavoring opens the outlet valve 24 and flows into the measuring cup 4 through the outlet pipe 6, the piston rod outlet 10, the sleeve opening 27 and the pump lid exhausting cavity 44. In the other embodiment, when used, the user presses the pressuring arm 31 to drive the piston rod sleeve 62 and the piston rod 29 to move downwardly. At the beginning, the piston 26 is pushed by the liquid flavoring in the pump 18 and does not move downwardly with the piston rod 29 until the piston rod sleeve bevel 61 of the piston rod sleeve 62 contacts with the piston upper bevel 66 and pushes the piston 26 to move downwardly and presses the liquid flavoring, meanwhile, the piston lower bevel 65 has left the cone frustum bevel 64, and the piston rod inlet 56 has released and the pressed liquid flavoring flows into the measuring cup 4 through the inlet cutout 53, the piston rod inlet 56, the outlet pipe 6, the piston rod outlet 10, the piston rod sleeve outlet 59, the sleeve opening 27, and the pump lid exhausting cavity 44. At this moment, the user could clearly know the flavoring amount at any time by reading the measuring scale 42 of the measuring cup 4. When the flavoring amount reaches to the target amount, the pressing arm 31 is released so that the spring 28 pushes the piston 26, the piston rod 29 and the pressing arm 31 upwardly, and the pressure in the inner cavity of the pump 18 turns into negative pressure, which causes the outlet valve 24 be closed and immediately stops the liquid flavoring from flowing into the measuring cup 4. Meanwhile, the liquid flavoring in the pot opens the inlet valve 21 and is pumped into the pump 18. When the piston 26, the piston rod 29 and the pressing arm 31 turn back to its original position, the pump 18 is filled with the liquid flavoring. In the other embodiment, when releasing the pressing arm 31, the spring 28 pushes the piston rod 29, the piston rod sleeve 62 and the pressing arm 31 upwardly. At the beginning, because of the friction generated between the piston 26 and the inner wall of the pump 18, the piston 26 does not move upwardly with the piston rod 29, until the piston lower bevel 65 contacts with the cone frustum bevel 64, meanwhile, the piston rod inlet 56 is closed, and the piston 26 moves upwardly with the cone frustum 63, causes the pressure in the inner cavity of the pump 18 turn into negative pressure, and the liquid flavoring in the pot opens the inlet valve 21 and is pumped into the pump 18. When the piston 26, the piston rod 29, the piston rod sleeve 62 and the pressing arm 31 turn back to its original position, the pump 18 is filled with the liquid flavoring.

If the first time of operation could not make the amount reach to the target amount, the operation could be continuously performed until the amount reaches to the target amount, meanwhile, the pressing arm is released immediately and the liquid flavoring feeding is stopped immediately. Then, the liquid flavoring in the measuring cup 4 is poured out for use. After pouring out the liquid flavoring, the liquid residues at the spout 11 flows to the groove bottoms 15 of the grooves 12 along the outer wall of the spout 11, and returns back to the measuring cup 4 through the cup slots 14.

Furthermore, the present invention is not limited by the forgoing embodiments, the oil pot and/or flavoring pot utilizing measuring cup to receive the liquid pressed out from the pot, and disposing measuring scale on the measuring cup to measure the volume of accepted liquid are in the range of the present invention. Besides, the measuring cup may be stepping shaped, or the liquid squeezing structure may be vapour-pressure type or electric pump type, or the groove may be pocket shaped to receive the residue liquid flown along the outer wall of the spout, and other structures such as guide pipe may be used to guide the liquid to the measuring cup or the pot cavity are embodiments of the present invention.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An oil and flavoring pot, comprising:
a pot body having a pot opening, a spout, a handle, a liquid squeezing structure, a measuring cup and a residue recycling structure, the liquid squeezing structure being detachably attached to the pot opening, the measuring cup communicating with an inner cavity of the pot body through the liquid squeezing structure, the spout being disposed to a mouth of the measuring cup; wherein
the residue recycling structure comprises at least a groove formed beneath the spout and at least a cup slot formed on a sidewall of the measuring cup, the groove bypasses the mouth of the measuring cup, slantingly and downwardly extends to the outer wall of the pot body, the cup slot is defined in a cup wall of the measuring cup at positions corresponding to a connection portion of the groove and the pot body, liquid residues at the spout flowing into the measuring cup through the groove and the cup slot, and the measuring cup has a measuring scale and a capacity value formed on the measuring cup.

2. The oil and flavoring pot according to claim 1, wherein the liquid squeezing structure comprises a bracket, a pump lid and a pressing arm, the bracket has a pump, a pump inlet is disposed at a lower portion of the pump, an inlet valve is disposed beneath the pump inlet, a straw is connected beneath the inlet valve, a piston is disposed in the pump, a first spring is disposed between a bottom surface of the piston and the inlet valve, a piston rod is disposed at a top end of the piston, a top end of the piston rod is connected with a middle portion of the pressing arm, an outlet pipe is disposed inside the piston rod, a bottom end of the outlet pipe communicates with an inner cavity of the pump, a piston rod outlet is formed on an outer round wall of the piston rod, the piston rod outlet communicates with a top portion of the outlet pipe of the piston rod, an outlet valve is disposed inside the outlet pipe, a second spring is disposed between the outlet valve and a top surface of the outlet pipe, a pump lid is disposed on an upper portion of the pump, a sleeve and a pump lid exhausting cavity are disposed on the pump lid, the sleeve is disposed around the piston rod, a sleeve opening is defined in the sleeve and communicates with the piston rod outlet, the pump lid exhausting cavity respectively communicates with the sleeve opening and the measuring cup, a pin is disposed on the bracket and hinged with an end of the pressuring arm, a top lid is disposed on the bracket and a top lid cutout is defined in the top lid, the other end of the pressuring arm extends beyond the top lid cutout and capable of swinging up and down in the top lid cutout.

3. The oil and flavoring pot according to claim 1, wherein the liquid squeezing structure comprises a bracket, a pump lid and a pressing arm, the bracket has a pump, a pump inlet is disposed at a lower portion of the pump, an inlet valve is disposed beneath the pump inlet, a straw is connected beneath the inlet valve, a piston rod is disposed in the pump, a flange is formed at a bottom end of the piston rod, a plurality of inlet cutouts are defined in an outer round wall of the flange, a first spring is disposed between a bottom surface of the flange of the piston rod and the inlet valve, a cone frustum is formed on the flange, and the cone frustum is surrounded by a cone frustum bevel, an outlet pipe is disposed inside the piston rod, a bottom end of the outlet pipe extends to a top end of the cone frustum, a piston rod inlet is formed on an outer round wall of the piston rod at a position corresponding to a bottom end of the outlet pipe, and the piston rod inlet communicates with the outlet pipe, a piston rod outlet is formed on an outer round wall of the piston rod at a position corresponding to a top end of the outlet pipe, the piston rod outlet communicates with the outlet pipe, a piston rod sleeve is disposed around the piston rod, a top end of the piston rod sleeve connects with a middle portion of the pressing arm, a piston rod sleeve bevel is formed around a lower outer round wall of the piston rod sleeve, a piston rod sleeve outlet is formed on an outer round wall of the piston rod sleeve at a position corresponding to the piston rod outlet, the piston rod sleeve outlet communicates with the piston rod outlet, a trunk piston is disposed between the piston rod sleeve and the flange, the piston is capable of moving between the flange and the piston rod sleeve, an outer diameter of the piston matches with an inner diameter of the pump, a piston upper bevel is formed around an upper inner round wall of the piston and the piston upper bevel matches with the piston rod sleeve bevel, a piston lower bevel is formed around a lower inner round wall of the piston and the piston lower bevel matches with the cone frustum bevel, a pump lid is disposed on a top portion of the pump, a sleeve and a pump lid exhausting cavity are disposed on the pump lid, the sleeve is disposed around the piston rod sleeve, a sleeve opening is defined in the sleeve and communicates with piston rod sleeve outlet, the pump lid exhausting cavity respectively communicates with the sleeve opening and the measuring cup, a pin is disposed on the bracket and hinged with an end of the pressuring arm, a top lid is disposed on the bracket and a top lid cutout is defined in the top lid, the other end of the pressuring arm extends beyond the top lid cutout and capable of swinging up and down in the top lid cutout.

4. The oil and flavoring pot according to claim 2, wherein the detachable attachment includes a pump flange formed on an outer wall of the pump, a pot lid is disposed between the pump flange and the bracket, screw threads formed on the pot lid match with screw threads formed on the pot opening, a sealing pad is disposed between the pump flange and the pot opening.

5. The oil and flavoring pot according to claim 2, wherein a recess is formed at the top end of the piston rod sleeve, a protrusion is formed at a middle portion of the pressing arm and matches with the recess.

6. The oil and flavoring pot according to claim 3, wherein a recess is formed at the top end of the piston rod sleeve, a protrusion is formed at a middle portion of the pressing arm and matches with the recess.
